(19) United States
(12) Patent Application Publication
(10) Pub. No.: US 2004/0251125 A1
(43) Pub. Date: Dec. 16, 2004

(54) Breathing air refreshing arrangement

(76) Inventor: Eukki Qi Yu, City of Industry, CA (US)

Correspondence Address: Raymond Y. Chan, Suite 128, 108 N. Ynez Ave., Monterey Park, CA, 91754, US

(21) Appl. No.: 10/457,326

(22) Filed: Jun. 10, 2003

(51) Int. Cl. H05F 3/00; C01B 13/10; B01J 19/08

(52) U.S. Cl. 204/176; 204/164; 422/186.07

(57) ABSTRACT

A breathing air refreshing arrangement includes an ozone generator adapted for producing a flow of ozone to mix with a flow of air, and a depolarizing filter comprising an ion carrier containing positively charged ions for depolarizing the airflow. Therefore, when the airflow passes through the breathing air refreshing arrangement, the breathing air refreshing arrangement is adapted to purify the airflow to the fresh air by enriching the oxygen quality and removing the microbial contaminants in the airflow.

### BACKGROUND OF THE PRESENT INVENTION

1. Field of Invention

The present invention relates to an air purifier, and more particularly to a breathing air refreshing arrangement which employs with ozone and nano technologies to purify the surrounding air to the fresh air by enriching the oxygen quality and killing the microbial contaminants.

2. Description of Related Arts

Air pollution is aggravated because of rapid economic development and industrialization wherein air pollution has become a global problem. In order to reduce the air pollution, there are two major solutions: enriching the oxygen quality and killing the microbial contaminants.

Nowadays, ozone is one of the common elements to purify the air. Ozone is called activated oxygen and contains three atoms of oxygen instead of the normal oxygen having two oxygen atoms that we breathe. It is known that ozone is one of the strongest oxidizer in the world wherein ozone is commonly used for disinfecting, detoxification, and air deodorization, as well as food preservation.

There are basically two methods of producing ozone, which are ultra-violet and corona discharge. Most ozone generator uses the corona discharge method, simulating in essence, lightning. Ozone generator utilizing UV is hard to find because it is inefficient and unreliable, and very costly to service compared to the corona discharge equipment.

The theory of the corona discharge is to ionize the air to produce ozone. Accordingly, an electron reacts with oxygen to break down the oxygen into the oxygen atom wherein the oxygen atom is then reacted with another oxygen to form ozone.

e+O₂→2O+e

O+O₂→O₃

Nanotechnology is defined by the length scale when scientists and engineers discover new phenomena. It provides exquisite new tools to engineer novel materials and devices at nanoscale, and to study biology. A nanometer, one billionth of a meter, is about 10,000 times narrower than a human hair. Accordingly, after the nano process, physical structure, such as molecular arrangement and crystal lattice, of the material have been changed. Even though the material at the nano state remains its physical and chemical properties in comparison with the normal state, nano material provides larger surface area such that the nano material enhances the physical and/or chemical reaction with other reactant. Therefore, when the medicine employs with the nanotechnology, the medicine can be effectively absorbed by the human body. In addition, the nanotechnology is capable of using in the coating process because the coating material having nano properties provides an active surface area to enhance the adhesive ability of the coating material.

### SUMMARY OF THE PRESENT INVENTION

A main object of the present invention is to provide a breathing air refreshing arrangement which employs with ozone and nano technologies to purify the surrounding air to the fresh air by enriching the oxygen quality and killing the microbial contaminants.

Another object of the present invention is to provide a breathing air refreshing arrangement, which comprises an ozone generator for producing a flow of ozone to mix with a flow of air so as to enrich the oxygen quality of the airflow.

Another object of the present invention is to provide a breathing air refreshing arrangement, which comprises a depolarizing filter which comprises an ion carrier containing positively charged ions for depolarizing negative ions of the airflow, so as to remove the toxins and microbial contaminants through the depolarization of the air.

Another object of the present invention is to provide a breathing air refreshing arrangement, wherein the ion carrier, which is made of a powder form oxidized metallic element, is treated by nanotechnology so as to enhance the surface area of the ion carrier to effectively depolarize the air.

Another object of the present invention is to provide a breathing air refreshing arrangement, wherein the ozone occurs naturally in the environment and no chemical substance is required to be used on the depolarizing filter to chemically react with the airflow in such a manner the present invention substantially purities the airflow by removing the harmful substance and by increasing the amount of oxygen. In other words, the breathing air refreshing arrangement of the present invention is safe to use because no artificial or chemical substance is added into the airflow through the purification process.

Another object of the present invention is to provide a breathing air refreshing arrangement, which is easy to use and is capable of widely utilizing on various applications, such as an exhaust tube of a vehicle, a duct of a ventilation system, or even built-in with a portable air purifying machine.

Accordingly, in order to accomplish the above objects, the present invention provides a breathing air refreshing arrangement, comprising:

an ozone generator adapted for producing a flow of ozone to mix with a flow of air; and

a depolarizing filter comprising an ion carrier containing positively charged ions for depolarizing the airflow.

The present invention further comprises a method of refreshing an airflow, comprising the steps of:

(a) producing a flow of ozone to mix with the airflow; and

(b) depolarizing the airflow through a depolarizing filter, wherein the depolarizing filter comprises an ion carrier containing positively charged ions to depolarize the airflow when the airflow passes through the depolarizing filter.

These and other objectives, features, and advantages of the present invention will become apparent from the following detailed description, the accompanying drawings, and the appended claims.

### BRIEF DESCRIPTION OF THE DRAWINGS

FIG. 1 is a sectional perspective view illustrating a refreshing process for a breathing air refreshing arrangement according to a preferred embodiment of the present invention.

FIG. 2 illustrates an alternative mode of a depolarizing filter of the breathing air refreshing arrangement according to the above preferred embodiment of the present invention.

FIG. 3 illustrates the breathing air refreshing arrangement incorporating with an air purifying device according to the above preferred embodiment of the present invention.

FIG. 4 illustrates the breathing air refreshing arrangement incorporating with an exhaust system of a vehicle according to the above preferred embodiment of the present invention.

FIG. 5 illustrates the breathing air refreshing arrangement incorporating with a duct of a ventilation system according to the above preferred embodiment of the present invention.

### DETAILED DESCRIPTION OF THE PREFERRED EMBODIMENT

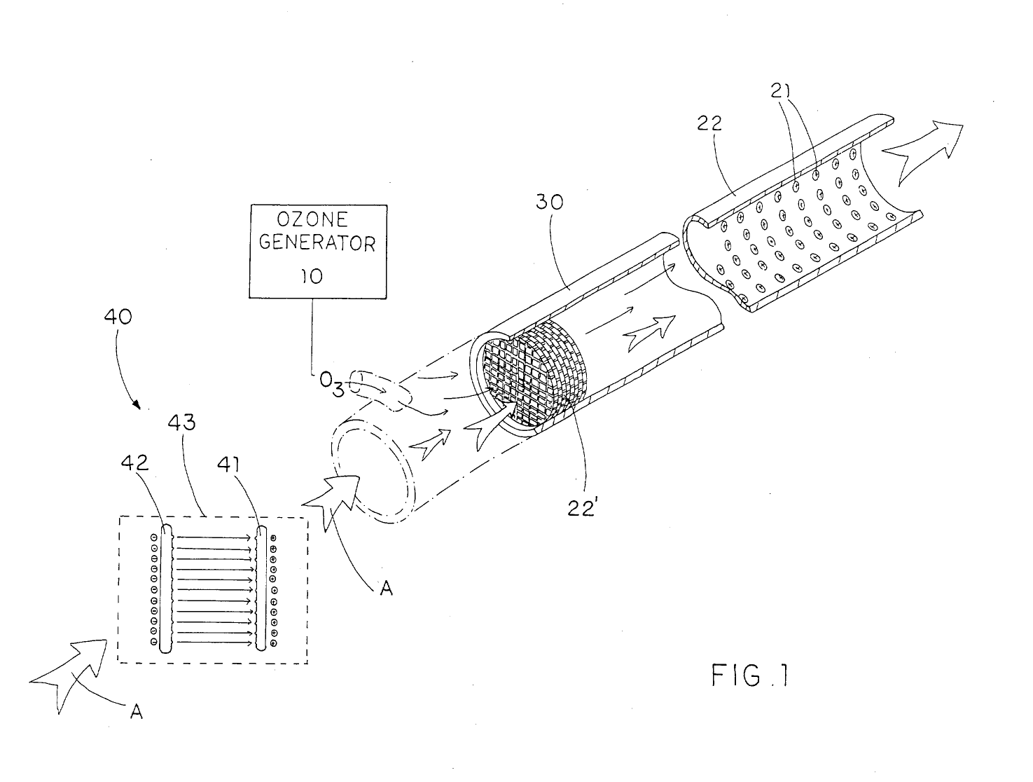

Referring to FIG. 1 of the drawings, a breathing air refreshing arrangement according to a preferred embodiment of the present invention is illustrated, wherein the breathing air refreshing arrangement comprises an ozone generator 10 adapted for producing a flow of ozone O₃ to mix with a flow of air A, and a depolarizing filter 20 comprising an ion carrier 21 containing positively charged ions for depolarizing the airflow A.

The breathing air refreshing arrangement further comprises a tubular guiding channel 30 communicatively connected to the ozone generator 10 for guiding the airflow A to pass through the guiding channel 30 so as to mix with the ozone O₃ therewithin in an air concealed manner. Accordingly, the guiding channel 30 is an elongated tube to guide the ozone O₃ passing therethrough wherein the ozone generator 10 produces the ozone O₃ towards the guiding channel 30, a sucking effect is created by the flow of ozone O₃ within the guiding channel 30 so as to suck the surrounding air into the guiding channel 30 to form the airflow A.

The present invention further provides a method of refreshing the airflow A, comprising the steps of:

(1) Produce a flow of ozone O₃ to mix with the airflow A.

(2) Depolarize the airflow A through the depolarizing filter 20.

It is worth to mention that when the airflow A, such as a recycling airflow, mixes with the ozone O₃, the oxygen quality in the airflow A is substantially increased. Since the ozone O₃, which is called activated oxygen, is unstable, ozone O₃ always reverts back to its original form, oxygen, after oxidation. In addition, since ozone O₃ is one of the strongest oxidizer, the ozone O₃ is adapted to function as an air deodorization to remove the odor in the airflow A.

Furthermore, ozone O₃ further oxidized inorganic materials such as iron, manganese, heavy metals, cyanide, sulfides, and nitrates in the airflow A such that the metallic substance in the airflow A will be substantially removed when the ozone 03 mixes with the airflow A.

The depolarizing filter 20, according to the preferred embodiment, further comprises an air passageway 22 integrally and communicatively extended from the guiding channel 30 for allowing the airflow A to pass therefrom wherein the ion carrier 21 is provided at an inner wall of the air passageway 22 in such a manner that the ion carrier 21 is capable of depolarizing the airflow A when the airflow A passes through the air passageway 22.

The ion carrier 21 is made of powder form oxidized metallic element, for example by grinding, such as copper which is positively charged to load with the positively charged ions. It is worth to mention that other metallic elements such as zinc, gold, or pure sliver can be used to substitute the copper to make the fine powder form ion carrier 21. The oxidized metallic element is treated through the nano process to form the ion carrier 21 wherein a size of the powder of the oxidized metallic element is about 1 nanometer.

Due to the nano properties of the oxidized metallic element, the ion carrier 21 is capable of affixing on the inner wall of the air passageway 22 wherein the ion carrier 21 creates a positive electric field within the air passageway 22 for depolarizing the airflow A passing therethrough. According to the preferred embodiment, the positive electric field created by the ion carrier 21 is about three positive charges (3+).

According to the preferred embodiment, the air passageway 22 is preferred made of silicon wherein the ion carrier 21 is affixed on the air passageway 22 by applying the powder form oxidized metallic element on the inner wall of the air passageway 22 through a heat treatment. In addition, the air passageway 22 has a plurality of micro pores for allowing the airflow A to pass through so as to filter out the impure substance, such as microbial contaminants, in the airflow A. It is worth to mention that the air passageway 22 is treated through the nano process to form the micro pores on the air passageway 22.

Accordingly, the microbial contaminants can only grow under a negative electric field condition. In other words, the negative ions within the airflow A will enhance the growth of the microbial contaminants. In order to remove the microbial contaminants in the airflow A, the depolarizing filter 20 is arranged to filter the airflow A where the microbial contaminants locate. Due to the present of the strong positive electric field created by the ion carrier 21, the depolarization rapidly proceeds within the air passageway 22 that the smaller amount of negative ion in the airflow A will be rapidly neutralized by the numerous quantity of positively charged ions of the ion carrier 21. When the negative ions in the airflow A are depolarized, the airflow A does not contain any negative ions. Therefore, the microbial contaminants will be inevitably killed in the airflow A under the neutralized condition of the airflow A.

In addition, the microbial contaminants will produce odor in the airflow A. Therefore, once the microbial contaminants are removed from the airflow A, the odor will be concurrently removed from the airflow A. In other words, the ion carrier 21 is capable of not only removing the microbial contaminants in the airflow A to provide a hygienic condition of the air but also eliminating the odor in the airflow A to further enhance the deodorization process of the breathing air refreshing arrangement. Therefore, the breathing air refreshing arrangement of the present invention provides double-feature purification process for purifying the air into fresh air.

As shown in FIG. 1, the breathing air refreshing arrangement further comprises an air ionizing filter 40 disposed within the guiding channel 30 for creating an electric field to comb the airflow A when the airflow A passes through the guiding channel 30. The air ionizing filter 40 has a positive charged terminal 41 and a negative charged terminal 42 supported within the guiding channel 30 for allowing the airflow A to pass through between the positive and negative charged terminals 41, 42 so as to ionize the airflow A within the guiding channel 30.

As shown in FIG. 1, the air ionizing filter 40 is electrically connected to a power source to create the electric field within the air ionizing filter 40 so as to form the positively charged ions at the positive charged terminal 41 and the negatively charged ions at the negative charged terminal 42. The electric filed is created by an ionizing voltage, having a range from 50000 to 100000 V, provided to the air ionizing filter 40 such that the negatively charged ions at the negative charged terminal 42 jump towards the positive charged terminal 41 to ionize the airflow A, wherein the sparking frequency of the positively charged ions is approximately 100 times per second while a distance between the positive and negative charged terminals 41 is about 1 mm to 30 mm.

The air ionizing filter 40 further has a sealed chamber 43 wherein the positive and negative charged terminals 41, 42 are received in the sealed chamber 43 to avoid the electric leakage of the positive and negative charged terminals 41, 42, so as to prevent any electric shock to the user.

Accordingly, when the relatively high ionizing voltage of the electric filed is applied at the airflow A, the electric field functions as a comb to comb the airflow A so as to kill the microbial contaminants, such as virus, within the airflow A. Therefore, when the airflow A passes through the air ionizing filter 40, the airflow A is ionized to remove the microbial contaminants therewithin. Then, when the airflow A passes through the air passageway 22, the carcass of the microbial contaminants within the airflow A will be filtered out, so as to release the fresh air to outside.

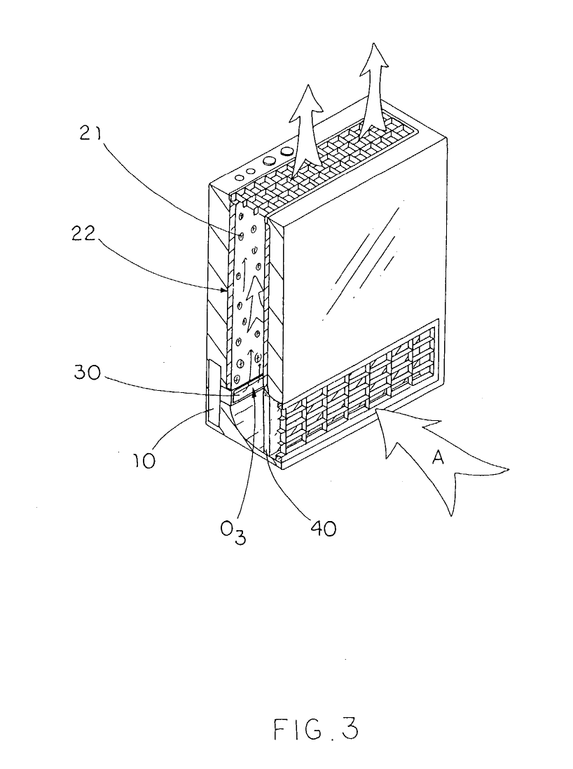

As shown in FIG. 3, the breathing air refreshing arrangement of the present invention is capable of incorporating with a conventional air purifying device wherein when the surrounding air is sucked into an air inlet of the air purifying device to form the airflow A, the airflow A is guided to pass through the guiding channel 30 while the ozone generator 10 produces the ozone O₃ towards the guiding channel 30 so as to mix with the airflow A. Then, the airflow A is guided to flow towards the air passageway 22 to depolarize with the ion carrier 21 such that the fresh air discharges from an air outlet of the air purifying device to outside. Therefore, for indoor use, the air purifying device is capable of circulating the air in a room to refresh the room air by enriching the oxygen quality and removing the microbial contaminants in the room air.

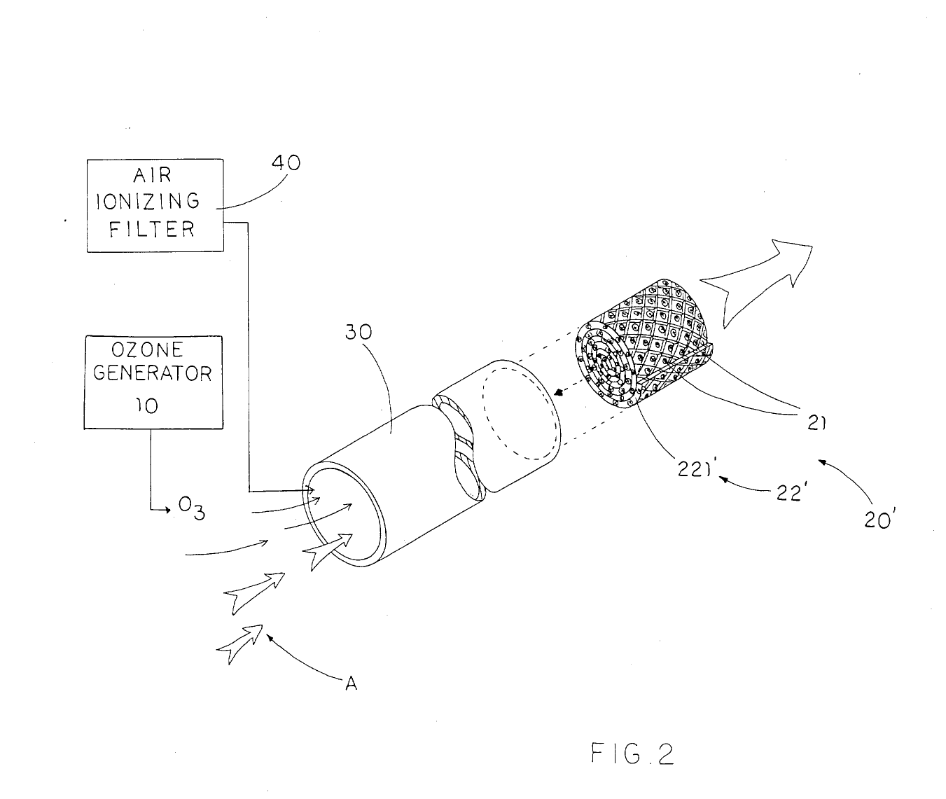

FIG. 2 illustrates an alternative mode of the depolarizing filter 20′ which comprises a filtering core 22′ disposed in the guiding channel 30 for allowing the airflow A to pass therethrough wherein the ion carrier 21 is provided at the filtering core 22′ in such a manner that the ion carrier 21 is capable for depolarizing the airflow A when the airflow A passes through the filtering core 22′ within the guiding channel 30.

The filtering core 22′ is made of a net shaped filtering guider 221′, having a plurality of air meshes, in a rolled manner adapted for allowing the airflow A to pass through the air meshes, wherein the ion carrier 21 is provided on the filtering guider 221′ to load the positively charged ions thereon. Accordingly, the filtering core 22′ enhance the contacting area between the airflow A and the ion carrier 21 when the airflow A passes through the air meshes of the filtering guider 221′ so as to enhance the depolarization process of the ion carrier 21 with respect to the airflow A. Preferably, the filtering guider 221′ is made of nylon to substantially hold the ion carrier 21 thereon.

Accordingly, the ion carrier 21 is formed by grinding the oxidized metallic element into a fine powder form wherein the powder form oxidized metallic element is then affixed on the filtering guider 221′ by adhering. Therefore, the filtering guider 221′ is adapted to be rolled to form the filtering core 22′ to fit into the guiding channel 30. It is worth to mention that the guiding channel 30 is treated through the nano process to form the micro pores on the guiding channel 30 so as to function as the air passageway 22 as mentioned above.

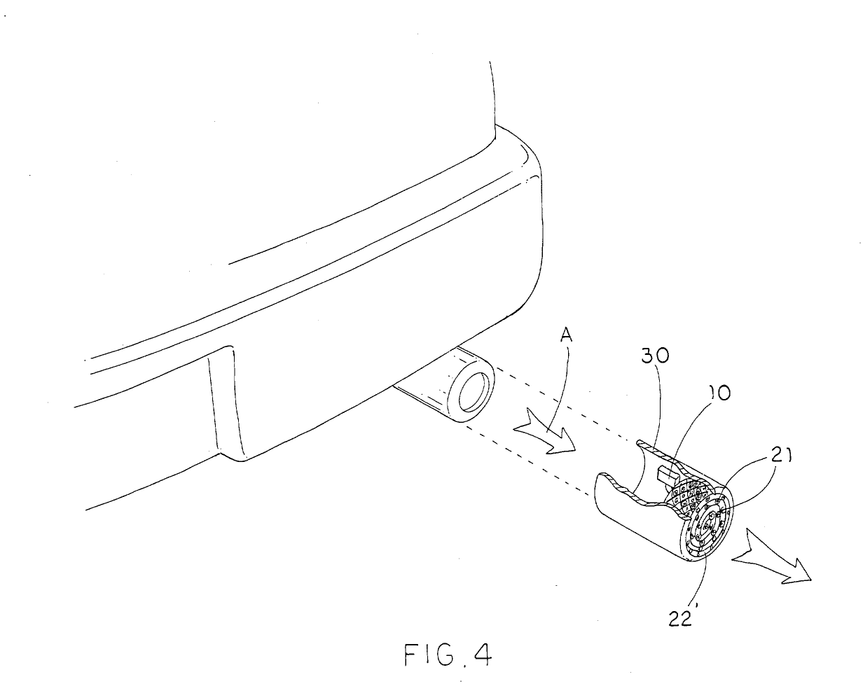

As shown in FIG. 4, the breathing air refreshing arrangement of the present invention is capable of installing into an exhaust system of a vehicle wherein the guiding channel 30 is mounted to an exhaust outlet of the vehicle in such a manner that when the exhaust gas is discharged from the exhaust system towards the guiding channel 30 to form the airflow A, the exhaust gas is mixed with the ozone O₃ to remove the metallic substance from the exhaust gas and to enrich the oxygen quality thereof. Then, the exhaust gas is guided to pass through the filtering core 22′ to depolarize with the ion carrier 21 so as to purify the exhaust gas to become the fresh air. It is worth to mention that the air ionizing filter 40 can be omitted when the breathing air refreshing arrangement of the present invention is installed into the exhaust system of the vehicle since the exhaust gas contains a high level of chemical substance, such as carbon monoxide or sulphur dioxide, instead of the microbial contaminants.

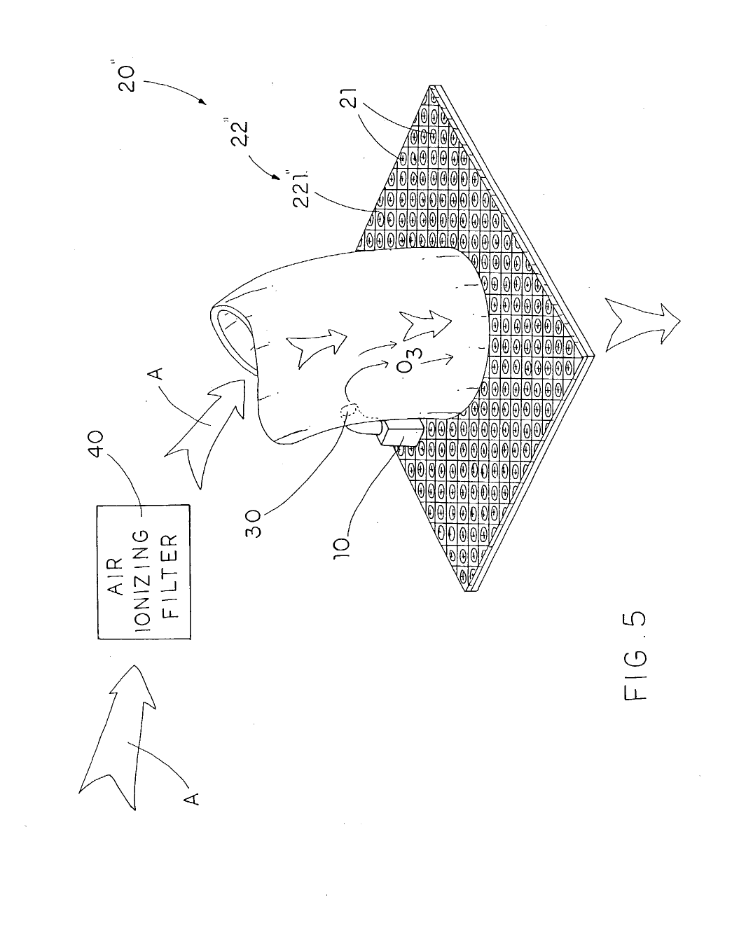

FIG. 5 illustrates that the breathing air refreshing arrangement of the present invention is capable of incorporating with a ventilation system wherein the guiding channel 30 is embodied as a duct of the ventilation system for guiding the airflow A to mix with the ozone O₃ after the airflow A pass through the air ionizing filter 40. The depolarizing filter 20″ comprises at least a net shaped filtering guider 221″ positioning at an opening of the guiding channel 30 and having a plurality of air meshes adapted for allowing the airflow A to pass through the air meshes, wherein the ion carrier 21 is provided on the filtering guider 221″ to load the positively charged ions thereon in such a manner that the ion carrier 21 on the filtering guider 221″ is adapted for depolarizing the airflow A when the airflow A passes through the air meshes of the filtering guider 221″ from the opening of the guiding channel 30.

Accordingly, the opening of the guiding channel 30 is embodied as an outlet of the duct of the ventilation system wherein the depolarizing filter 20″ is preferably constructed by more than two filtering guiders 221″ in an overlapped manner so as to enhance the depolarization of the airflow A by increasing the contacting area between the airflow A and the ion carrier 21. In addition, the air ionizing filter 40 should be provided at the guiding channel 30 to kill the microbial contaminants, such as virus, within the airflow A when the airflow A passes through the guiding channel 30.

In addition, the depolarizing filter 20″ can be positioned at an inlet of the ventilation system wherein the airflow A passes through the depolarizing filter 20″ before the air is sucked into the inlet of the duct of the ventilation system. Therefore, the intake air will be cleaned and refreshed before entering into the ventilation system so as to keep the ventilation system clean. It is worth to mention that the ventilation system generally has one air inlet and a plurality of air outlets such that when the intake air is cleaned and refreshed before sucking into the ventilation system, the discharging air from the air outlets will become fresh air so as to enhance the air cleaning process through the breathing air refreshing arrangement of the present invention.

In view of above, the ozone O₃ occurs naturally in the environment and no chemical substance is required to be used on the depolarizing filter 20 to chemically react with the airflow A in such a manner the present invention substantially purities the airflow A by removing the harmful substance and by enriching the amount of oxygen. In other words, the breathing air refreshing arrangement of the present invention is safe to use because no artificial or chemical substance is added into the airflow A through the purification process.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A breathing air refreshing arrangement, comprising:
a guiding channel for guiding a flow of air passing therethrough;
an ozone generator adapted for producing a flow of ozone to mix with said airflow within said guiding channel; and
a depolarizing filter comprising an ion carrier containing positively charged ions for depolarizing said airflow.

2. The breathing air refreshing arrangement, as recited in claim 1, wherein said ion carrier is made of a powder form oxidized metallic element which is positively charged to load with said positively charged ions on.

3. The breathing air refreshing arrangement, as recited in claim 1, further comprising an air ionizing filter disposed within said guiding channel for applying an ionizing voltage having positive charges at said airflow when said airflow passes through said guiding channel, wherein said air ionizing filter has a plurality of air ionizing grooves axially extended along said guiding channel for allowing said airflow to pass through so as to ionize said airflow within said air ionizing grooves.

4. The breathing air refreshing arrangement, as recited in claim 2, further comprising an air ionizing filter disposed within said guiding channel for creating an electric field to comb said airflow when said airflow passes through said guiding channel, wherein said air ionizing filter has a positive charged terminal and a negative charged terminal supported within said guiding channel for allowing said airflow to pass through between said positive and negative charged terminals so as to ionize said airflow within said guiding channel.

5. The breathing air refreshing arrangement, as recited in claim 1, wherein said depolarizing filter further comprises an air passageway communicatively extended from said guiding channel for allowing said airflow to pass therefrom, wherein said ion carrier is provided at an inner wall of said air passageway in such a manner that said ion carrier is capable of depolarizing said airflow when said airflow passes through said air passageway.

6. The breathing air refreshing arrangement, as recited in claim 2, wherein said depolarizing filter further comprises an air passageway communicatively extended from said guiding channel for allowing said airflow to pass therefrom, wherein said ion carrier is provided at an inner wall of said air passageway in such a manner that said ion carrier is capable of depolarizing said airflow when said airflow passes through said air passageway.

7. The breathing air refreshing arrangement, as recited in claim 4, wherein said depolarizing filter further comprises an air passageway communicatively extended from said guiding channel for allowing said airflow to pass therefrom, wherein said ion carrier is provided at an inner wall of said air passageway in such a manner that said ion carrier is capable of depolarizing said airflow when said airflow passes through said air passageway.

8. The breathing air refreshing arrangement, as recited in claim 1, wherein said depolarizing filter further comprises a filtering core disposed in said guiding channel for allowing said airflow to pass therethrough, wherein said ion carrier is provided at said filtering core in such a manner that said ion carrier is capable for depolarizing said airflow when said airflow passes through said filtering core within said guiding channel.

9. The breathing air refreshing arrangement, as recited in claim 2, wherein said depolarizing filter further comprises a filtering core disposed in said guiding channel for allowing said airflow to pass therethrough, wherein said ion carrier is provided at said filtering core in such a manner that said ion carrier is capable for depolarizing said airflow when said airflow passes through said filtering core within said guiding channel.

10. The breathing air refreshing arrangement, as recited in claim 4, wherein said depolarizing filter further comprises a filtering core disposed in said guiding channel for allowing said airflow to pass therethrough, wherein said ion carrier is provided at said filtering core in such a manner that said ion carrier is capable for depolarizing said airflow when said airflow passes through said filtering core within said guiding channel.

11. The breathing air refreshing arrangement, as recited in claim 8, wherein said filtering core is made of a net shaped filtering guider, having a plurality of air meshes, in a rolled manner adapted for allowing said airflow to pass through said air meshes, wherein said ion carrier is provided on said filtering guider to load said positively charged ions thereon.

12. The breathing air refreshing arrangement, as recited in claim 9, wherein said filtering core is made of a net shaped filtering guider, having a plurality of air meshes, in a rolled manner adapted for allowing said airflow to pass through said air meshes, wherein said ion carrier is provided on said filtering guider to load said positively charged ions thereon.

13. The breathing air refreshing arrangement, as recited in claim 10, wherein said filtering core is made of a net shaped filtering guider, having a plurality of air meshes, in a rolled manner adapted for allowing said airflow to pass through said air meshes, wherein said ion carrier is provided on said filtering guider to load said positively charged ions thereon.

14. The breathing air refreshing arrangement, as recited in claim 1, wherein said depolarizing filter comprises at least a net shaped filtering guider positioning at an opening of said guiding channel and having a plurality of air meshes adapted for allowing said airflow to pass therethrough, wherein said ion carrier is provided on said filtering guider to load the positively charged ions thereon in such a manner that said ion carrier on said filtering guider is adapted for depolarizing said airflow when said airflow passes through said air meshes of said filtering guider from said opening of said guiding channel.

15. The breathing air refreshing arrangement, as recited in claim 2, wherein said depolarizing filter comprises at least a net shaped filtering guider positioning at an opening of said guiding channel and having a plurality of air meshes adapted for allowing said airflow to pass therethrough, wherein said ion carrier is provided on said filtering guider to load the positively charged ions thereon in such a manner that said ion carrier on said filtering guider is adapted for depolarizing said airflow when said airflow passes through said air meshes of said filtering guider from said opening of said guiding channel.

16. The breathing air refreshing arrangement, as recited in claim 4, wherein said depolarizing filter comprises at least a net shaped filtering guider positioning at an opening of said guiding channel and having a plurality of air meshes adapted for allowing said airflow to pass therethrough, wherein said ion carrier is provided on said filtering guider to load the positively charged ions thereon in such a manner that said ion carrier on said filtering guider is adapted for depolarizing said airflow when said airflow passes through said air meshes of said filtering guider from said opening of said guiding channel.

17. A method of refreshing an airflow, comprising the steps of:
(a) producing a flow of ozone to mix with said airflow; and
(b) depolarizing said airflow through an ion carrier containing positively charged ions.

18. The method, as recited in claim 17, further comprising a step of providing an electric field to ionize said airflow.

19. The method, as recited in claim 17, further comprising a step of guiding said airflow to pass through a guiding channel, wherein said ozone is mixed with said airflow within said guiding channel in an air concealed manner.

20. The method, as recited in claim 18, further comprising a step of guiding said airflow to pass through a guiding channel, wherein said ozone is mixed with said airflow within said guiding channel in an air concealed manner.

21. The method, as recited in claim 17, in step (b), wherein said airflow passes through a depolarizing filter while said ion carrier containing positively charged ions is loaded on said depolarizing filter for depolarizing said airflow when said airflow passes through said depolarizing filter.

22. The method, as recited in claim 20, in step (b), wherein said airflow passes through a depolarizing filter while said ion carrier containing positively charged ions is loaded on said depolarizing filter for depolarizing said airflow when said airflow passes through said depolarizing filter.

23. The method, as recited in claim 22, wherein said ion carrier is made of a powder form oxidized metallic element which is positively charged to load with said positively charged ions on said depolarizing filter.

24. The method, as recited in claim 17, wherein said depolarizing filter comprises an air passageway communicatively extended from said guiding channel for allowing said airflow to pass therefrom, wherein said ion carrier is provided at an inner wall of said air passageway in such a manner that said ion carrier is capable of depolarizing said airflow when said airflow passes through said air passageway.

25. The method, as recited in claim 23, wherein said depolarizing filter comprises an air passageway communicatively extended from said guiding channel for allowing said airflow to pass therefrom, wherein said ion carrier is provided at an inner wall of said air passageway in such a manner that said ion carrier is capable of depolarizing said airflow when said airflow passes through said air passageway.

26. The method, as recited in claim 17, wherein said depolarizing filter comprises a filtering core disposed in said guiding channel for allowing said airflow to pass therethrough, wherein said ion carrier is provided at said filtering core in such a manner that said ion carrier is capable for depolarizing said airflow when said airflow passes through said filtering core within said guiding channel.

27. The method, as recited in claim 23, wherein said depolarizing filter comprises a filtering core disposed in said guiding channel for allowing said airflow to pass therethrough, wherein said ion carrier is provided at said filtering core in such a manner that said ion carrier is capable for depolarizing said airflow when said airflow passes through said filtering core within said guiding channel.

28. The method, as recited in claim 17, wherein said depolarizing filter comprises at least a net shaped filtering guider positioning at an outlet of said guiding channel and having a plurality of air meshes adapted for allowing said airflow to pass therethrough, wherein said ion carrier is provided on said filtering guider to load the positively charged ions thereon in such a manner that said ion carrier on said filtering guider is adapted for depolarizing said airflow when said airflow passes through said air meshes of said filtering guider from said outlet of said guiding channel.

29. The method, as recited in claim 23, wherein said depolarizing filter comprises at least a net shaped filtering guider positioning at an outlet of said guiding channel and having a plurality of air meshes adapted for allowing said airflow to pass therethrough, wherein said ion carrier is provided on said filtering guider to load the positively charged ions thereon in such a manner that said ion carrier on said filtering guider is adapted for depolarizing said airflow when said airflow passes through said air meshes of said filtering guider from said outlet of said guiding channel.
